(19) United States
(12) Patent Application Publication
(10) Pub. No.: US 2015/0235253 A1
(43) Pub. Date: Aug. 20, 2015

(54) METHOD AND SYSTEM FOR GENERATING RELATIONSHIP BASED ON RECOMMENDATION

(71) Applicant: LG HOUSEHOLD & HEALTH CARE LTD., Seoul (KR)

(72) Inventors: Keun Su Kim, Seoul (KR); Young Dong Choi, Gimpo (KR)

(21) Appl. No.: 14/428,957

(22) PCT Filed: Dec. 3, 2012
(86) PCT No.: PCT/KR2012/010387

§ 371 Date: Mar. 17, 2015

(30) Foreign Application Priority Data
Sep. 21, 2012 (KR) 10-2012-0105303

(51) Int. Cl. G06Q 30/02

(52) U.S. Cl. CPC G06Q 30/0214; G06Q 30/0225

(57) ABSTRACT

The present invention relates to a method and a system for generating a relationship based on a recommendation, wherein a coupon including recommender information is transmitted to a potential client, the recommender information is acquired from the registered coupon, a relationship of a recommender and a recommendee is formed between the acquired recommender and the potential client registering the coupon, and compensation is provided when a product is purchased. The method for generating a relationship based on a recommendation, according to the present invention, comprises: a coupon generating step for generating the coupon including the recommender information; a coupon transmitting step for transmitting the generated coupon to the potential client; and an information acquiring step for acquiring the recommender information from the information of the registered or used coupon when the transmitted coupon is registered or used.

### TECHNICAL FIELD

The method invention relates to a recommendation relationship generating method and system. More particularly, the present invention relates to a recommendation relationship generating method and system that may send a coupon including recommender information to a potential customer, when the potential customer registers the sent coupon, generate, as a recommender-and-recommendee relationship, a recommender acquired by acquiring recommender information from the registered coupon and the potential customer having registered the coupon and provide compensation when the potential customer purchases a product.

### BACKGROUND ART

Marketing using a coupon and inducement for product purchase are methods used both offline and online.

Also, a method of providing compensation such as mileage and a gift to a recommender and a recommendee when a customer registers the recommender in joining a member at an online shop or an offline shop is utilized as marketing and customer attraction strategies.

However, in many cases, in an operation of registering a recommender, a customer does not register the recommender due to reasons such as inconvenience or not remembering the recommender correctly.

In this case, an entity to transfer a discount coupon and the like to a potential customer to be recommended may lose incentive while possibly incur financial damage and further, may not predict the number of recommendees to be secured.

Accordingly, there is a need for a recommender registering method that enables a potential customer to easily join a member or purchase a product through a person that desires to be recommended.

### DISCLOSURE

### Technical Problem

The present invention has been made to solve the aforementioned issues and is to provide a recommendation relationship generating method and system that may include recommender information in a serial number of a coupon and thereby generate a recommender-and-recommendee relationship without using a separate recommender registering operation when a potential customer uses the coupon.

### Technical Solution

A recommendation relationship generating method to solve the aforementioned issues may include a coupon generating operation of generating a coupon including recommender information; an information acquiring operation of acquiring identification information of a potential customer having registered or used the coupon and acquiring recommender information included in the registered or used coupon; and a recommendation relationship generating operation of generating a recommendation relationship between the recommender and the potential customer using information acquired in the information acquiring operation.

Desirably, the coupon generating operation may generate the coupon so that the recommender information is included in a serial number of the coupon.

Desirably, to generate the coupon so that the recommender information is included in the serial number of the coupon may generate the coupon so that the recommender information is included using any one of a character corresponding to a predetermined portion of the serial number and a combination of characters corresponding to predetermined locations of the serial number.

Desirably, the serial number of the coupon may include at least one of an ID of the recommender, an employee identification number, and a telephone number of the recommender.

Desirably, the recommendation relationship generating method may further include a compensation operation of providing compensation to the recommender based on a predetermined ratio of a financial activity scale of the potential customer with whom the recommendation relationship is generated spending at a place at which the recommendation relationship is applied.

Desirably, the compensation operation may vary the predetermined ratio based on the number of recommendees of the recommender.

Desirably, the recommendation relationship generating method may further include a coupon sending operation of sending the coupon generated in the coupon generating operation to the potential customer.

Desirably, the coupon sending operation may send the generated coupon using at least one of a short message service (SMS), a multimedia message service (MMS), a mobile messenger, and an e-mail.

A recommendation relationship generating system to solve the aforementioned issues may include a coupon generator configured to generate a coupon including recommender information; an information acquirer configured to acquire identification information of a potential customer having registered or used the coupon, and to acquire recommender information included in the registered or used coupon; and a recommendation relationship generator configured to generate a recommendation relationship between the recommender and the potential customer using information acquired by the information acquirer.

Desirably, the coupon generator may generate the coupon so that the recommender information is included in a serial number of the coupon.

Desirably, the serial number of the coupon may include at least one of an ID of the recommender, an employee identification number, and a telephone number of the recommender.

Desirably, to generate the coupon so that the recommender information is included in the serial number of the coupon may generate the coupon so that the recommender information is included using any one of a character corresponding to a predetermined portion of the serial number and a combination of characters corresponding to predetermined locations of the serial number.

Desirably, the recommendation relationship generating system may further include a compensator configured to provide compensation to the recommender based on a predetermined ratio of a financial activity scale of the potential customer with whom the recommendation relationship is generated spending at a place at which the recommendation relationship is applied.

Desirably, the compensator may vary the predetermined ratio based on the number of recommendees of the recommender.

Desirably, the recommendation relationship generating system may further include a coupon sender configured to send the coupon generated by the coupon generator to the potential customer.

Desirably, the coupon sender may send the generated coupon using at least one of an SMS, an MMS, a mobile messenger, and an e-mail.

A recommendation relationship generating method of generating a recommendation relationship between a recommender and a potential customer to solve the aforementioned issues may include an information acquiring operation of acquiring information of at least one of an identification code of the recommender, a telephone number of the potential customer, and a serial number of a coupon including information of the recommender; and a recommendation relationship generating operation of generating a recommendation relationship using the acquired information.

Desirably, the recommendation relationship generating operation may generate the recommendation relationship between the recommender corresponding to the acquired identification code of the recommender and the potential customer having input the identification code of the recommender when the identification code of the recommender is acquired in the information acquiring operation, may generate the recommendation relationship between the recommender having registered in advance the acquired telephone number of the potential customer and the potential customer when the telephone number of the potential customer is acquired in the information acquiring operation, and may acquire recommender information from the acquired serial number of the coupon, and generate the recommendation relationship between the recommender corresponding to the acquired recommender information and the potential customer having input the serial number of the coupon when the serial number of the coupon is acquired in the information acquiring operation.

Desirably, the acquiring of the recommender information from the serial number of the coupon may acquire the recommender information using any one of a character corresponding to a predetermined portion of the serial number and a combination of characters corresponding to predetermined locations of the serial number.

Desirably, the serial number of the coupon may include at least one of an ID of the recommender, an employee identification number, and a telephone number of the recommender.

Desirably, the recommendation relationship generating method may further include a compensation operation of providing compensation to the recommender based on a predetermined ratio of a financial activity scale of the potential customer with whom the recommendation relationship is generated spending at a place at which the recommendation relationship is applied.

Desirably, the compensation operation may vary the predetermined ratio based on the number of recommendees of the recommender.

Desirably, the recommendation relationship generating method may further include a coupon sending operation of sending the coupon including the recommender information to the potential customer.

Desirably, the coupon sending operation may send the generated coupon using at least one of an SMS, an MMS, a mobile messenger, and an e-mail.

A recommendation relationship generating method of generating a recommendation relationship between a recommender and a potential customer to solve the aforementioned issues may include generating the recommendation relationship between the recommender corresponding to an acquired identification code of the recommender and the potential customer having input the identification code of the recommender when the identification code of the recommender is acquired; generating the recommendation relationship between the recommender having registered in advance an acquired telephone number of the potential customer and the potential customer when the identification code of the recommender is not acquired and the telephone number of the potential customer is acquired; and acquiring recommender information from an acquired serial number of the coupon, and generating the recommendation relationship between the recommender corresponding to the acquired recommender information and the potential customer having input the serial number of the coupon when information about the identification code of the recommender and the telephone number of the potential customer are not acquired and the serial number of the coupon is acquired.

Desirably, the acquiring of the recommender information from the serial number of the coupon may acquire the recommender information using any one of a character corresponding to a predetermined portion of the serial number and a combination of characters corresponding to predetermined locations of the serial number.

Desirably, the serial number of the coupon includes at least one of an ID of the recommender, an employee identification number, and a telephone number of the recommender.

Desirably, the recommendation relationship generating method may further include a compensation operation of providing compensation to the recommender based on a predetermined ratio of a financial activity scale of the potential customer with whom the recommendation relationship is generated spending at a place at which the recommendation relationship is applied.

Desirably, the compensation operation may vary the predetermined ratio based on the number of recommendees of the recommender.

### Advantageous Effects

A recommendation relationship generating method and system according to the present invention may generate a recommender-and-recommendee relationship without using a separate recommender registering operation.

Accordingly, in the recommendation relationship generating method and system according to the present invention, a recommendee registers a recommender without inconvenience and thus, an entity to be recommended may easily secure a recommendee.

Also, the recommendation relationship generating method and system according to the present invention may provide compensation for an increase in sales according to a coupon use to a recommender even when it is impossible to generate a recommendation relationship due to absence of identification information of a potential customer.

### DESCRIPTION OF DRAWINGS

FIG. 1 is a block diagram illustrating a recommendation relationship generating system according to an exemplary embodiment of the present invention.

FIG. 2 is a view illustrating an example in which a coupon generated by a coupon generator of a recommendation relationship generating system according to the present invention is sent as a mobile text message.

FIG. 3 is a view illustrating another example in which a coupon generated by a coupon generator of a recommendation relationship generating system according to the present invention is sent as a mobile text message.

FIG. 4 is a block diagram illustrating a compensation system according to an exemplary embodiment of the present invention.

FIG. 5 is a flowchart illustrating a recommendation relationship generating method according to an exemplary embodiment of the present invention.

FIG. 6 is a flowchart illustrating a compensation method according to an exemplary embodiment of the present invention.

FIG. 7 is a flowchart illustrating a case in which a recommendation relationship generating method according to the present invention is combined with another recommendation relationship generating method.

FIG. 8 is a flowchart illustrating a recommendation relationship generating method according to still another exemplary embodiment of the present invention.

### BEST MODE

Hereinafter, exemplary embodiments of the present invention will be described in detail with reference to the accompanying drawings. Substantially like constituent elements in the following description and the accompanying drawings refer to like reference numerals, respectively, and thus, a repeated description will be omitted. Also, when it is determined that the detailed description related to a related known function or configuration may make the purpose of the present invention unnecessarily ambiguous in describing the present invention, the detailed description will be omitted here.

When it is described that a predetermined constituent element is “connected to” or “accessed to” another constituent element, the predetermined constituent element may be directly connected to or accessed to the other constituent element, however, should be understood that still another constituent element may be present between the predetermined constituent element and the other constituent element. On the other hand, when it is described that the predetermined constituent element is “directly connected to” or “directly accessed to” the other constituent element, it should be understood that still another constituent element is absent between the predetermined constituent element and the other constituent element.

In the present specification, unless particularly described in the sentence, a singular form may also include a plural form. “Includes (comprises)” and/or “including (comprising)” used in the present specification does not exclude the presence or addition of at least one another constituent element, step, operation, and/or device with respect to the described constituent element, step, operation, and/or device.

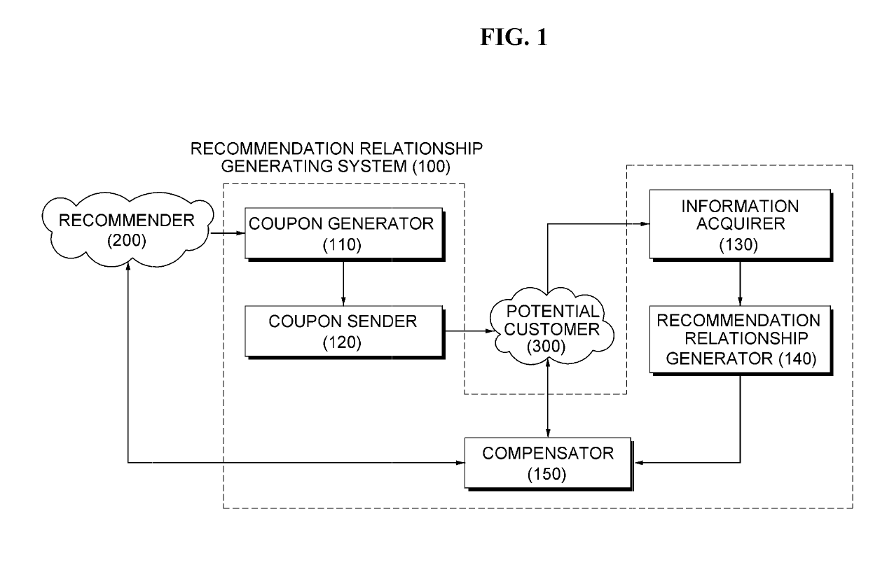

FIG. 1 is a block diagram illustrating a recommendation relationship generating system according to an exemplary embodiment of the present invention.

Referring to FIG. 1, the recommendation relationship generating system 100 includes a coupon generator 110, a coupon sender 120, an information acquirer 130, a recommendation relationship generator 140, and/or a compensator 150.

The coupon generator 110 generates a coupon including recommender information of a recommender 200.

The coupon generated by the coupon generator 110 may be generated online and provided online such as an e-mail, a short message service (SMS), and the like, or may be generated and thereby provided in a form of an offline documented coupon.

The coupon generator 110 may generate the coupon by receiving an identification code for identifying the recommender 200 from the recommender 200 that is to be recommended.

In detail, the coupon generator 110 may include recommender information of the recommender 200 using a serial number of the coupon.

That is, the coupon generator 110 may include the recommender information using a character corresponding to a predetermined portion of the serial number of the coupon, or may include recommender information using characters corresponding to predetermined locations of the serial number of the coupon.

For example, when the serial number of the coupon includes 13 digits using alphabetical characters and numbers, four digits of a head portion may indicate an identification code of the recommender 200 sending or providing the coupon to potential customers 300 to be recommended. The identification code may be a member join number, an employee identification number, and a predetermined number assigned to the recommender 200, and the identification code may be changed over time or depending on circumstances.

The potential customer 300 may be any person who may perform a financial activity aside from a person who is to make a recommendation, and may be various persons or groups such as a person of which a number is registered to a mobile phone, a person having made a relationship at an SNS, a relative, a friend, school alumni, or the same local resident.

Recommender information may be variously determined using a portion of the serial number of the coupon, such as four digits of an intermediate portion, four digits of a tail portion, and five digits of a head portion in addition to four digits of the head portion of the coupon. Also, recommender information may have the same identification code as characters described in the serial number. However, the recommender information may not be identical thereto and may also use a method of matching characters described in the serial number and the identification code.

As another example, when the serial number of the coupon includes 13 digits using alphabetical characters and numbers, the identification code of the recommender 200 sending the coupon to the potential customers 300 to be recommended may be indicated by combining second, fifth, tenth, and thirteenth characters among characters of the serial number.

The serial number of the coupon may include consonants or vowels of Korean characters and numbers instead of using alphabetical characters and numbers. When the identification code is indicated by combining characters corresponding to predetermined locations, the corresponding locations may be variously modified. Also, a predetermined character of the serial number of the coupon may be a character connected to an instruction that determines locations of characters to be combined.

For example, in a case in which the serial number of the coupon includes 12 digits, the coupon generator 110 may generate the coupon to indicate the identification code for identifying the recommender 200 by combining third, fourth, seventh, eighth, and twelfth characters when the second character is an odd number, and to indicate the identification code for identifying the recommender 200 by combining fourth, fifth, ninth, tenth, and eleventh characters when the second character is an even number.

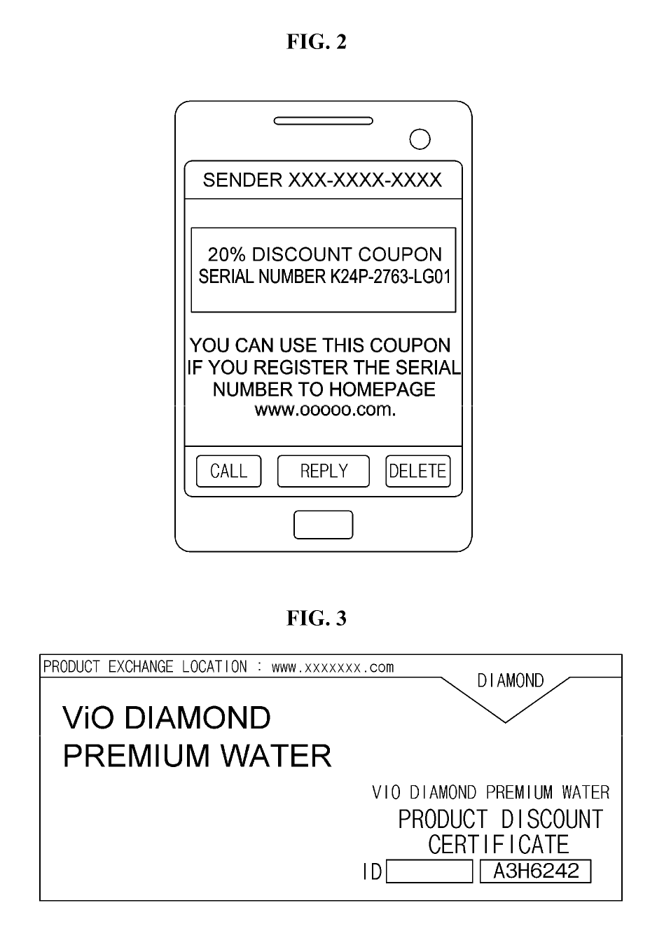

FIG. 2 is a view illustrating an example in which a coupon generated by a coupon generator of a recommendation relationship generating system according to the present invention is sent as a mobile text message, and FIG. 3 is a view illustrating another example in which a coupon generated by a coupon generator of a recommendation relationship generating system according to the present invention is sent as a mobile text message.

FIG. 2 illustrates an online coupon generated by the coupon generator 110 of the recommendation relationship generating system 100 according to an exemplary embodiment of the present invention. The online coupon is a coupon distributable to an Internet advertisement, a blog, an e-mail, and the like, using the Internet, and also includes a coupon that may be provided using wireless communication such as an SMS and an MMS. In a case in which the serial number of the coupon described above with reference to FIG. 2 includes 12 digits, when recommender information of the recommender 200 included in the coupon is acquired from the serial number of the coupon, the second character is 2, an even number and thus, P, 2, L, G, and 0 become the fourth, fifth, ninth, tenth, and eleventh characters. Accordingly, the serial number of the coupon illustrated in FIG. 2 includes information of a recommender having an identification code P2LG0.

The method proposed by using FIG. 2 as an example is only an example in which the coupon generator 110 generates the coupon by including recommender information. A combination order may not be sequential and the identification code acquired for security may be not the identification code of the recommender 200 but information to acquire matching recommender information from a database containing information of the recommender 200, and may also be a code having experienced an encoding process.

Also, combining characters corresponding to predetermined locations may indicate the identification code by simply sequentially arranging a character of each location and by changing and thereby arranging orders, and may also indicate the identification code through a preset operation equation.

FIG. 3 illustrates an example of an offline coupon. A type of the coupon may be a discount coupon of a predetermined product, and an identification code of a recommender may be described in an empty column in front of a discount coupon number (A3H6242). The identification code of the recommender may be a member ID of the recommender. Alternatively, an ID indication written in the empty column may be deleted and another identification code in a similar form to the discount coupon number used only for the coupon may also be described instead of using the member ID. An indication including the discount coupon number and a recommender identifier may also be regarded as the serial number of the coupon.

That is, recommender information may be included in the serial number of the coupon, and a portion of the serial number of the coupon may be at least one of a recommender ID, an employee identification number, and a recommender telephone number.

FIG. 3 is an example of an offline coupon. However, the coupon may be taken using a digital camera, a camera of a mobile phone, and the like, and may be distributed online such as an SMS, an MMS, an e-mail, a blog, and the like. Similarly, the coupon used as the example of FIG. 2 may also be provided using an offline manner through a printing process, instead of being provided online.

When the coupon generator 110 generates a coupon including information of the recommender 200, the coupon sender 120 sends the coupon to the potential customer 300. When the coupon is in an actual document form, the coupon may also be distributed offline.

The potential customer 300 that is a target to which the coupon sender 120 sends the coupon may be a person designated based on a mobile phone number, a mobile messenger ID, or an e-mail determined by the recommender 200, and may also be random.

The coupon sender 120 may send the coupon to the potential customer 300 using an SMS, an MMS, a mobile messenger, an e-mail, and the like.

When the potential customer 300 receives the sent coupon, and registers the serial number of the coupon on a computer to perform a member join, a product purchase, a coupon registration, a coupon use, and the like at an online shop, an offline shop, and the like described in the coupon, the information acquirer 130 acquires recommender information from the serial number of the registered coupon.

In detail, the information acquirer 130 acquires recommender information from the serial number of the coupon according to a method used for the coupon generator 110 to include the recommender information in the serial number of the coupon. A method of acquiring, by the information acquirer 130, recommender information may be preset. The setting may be changed in association with a method and a time used for the coupon generator 110 to include the recommender information, a change of an identification code of the recommender 200 or a security issue, and the like.

When information capable of identifying the potential customer 300 input from the potential customer 300 is present, the information acquirer 130 also acquires the input information of the potential customer 300. Information capable of identifying the potential customer 300 may be a residential registration number of the potential customer 300, a member join ID, a telephone number, and the like. Also, the information acquirer 130 may also combine at least two of information and thereby acquire information capable of identifying the potential customer 300, that is, an age, a name, a sex, a birth date, and the like.

Also, the information acquirer 130 may also acquire information about a financial activity scale triggered by use of the coupon and a financial activity scale of a person with whom the recommendation relationship is generated by the recommendation relationship generator 140 at a place at which the recommendation relationship is generated. The financial activity scale indicates product purchase cost, a service use amount, and the like.

When the information acquirer 130 acquires recommender information of the recommender 200 from the registered or used coupon, the recommendation relationship generator 140 generates a recommender-and-recommendee relationship using the recommender information acquired by the information acquirer 130 and potential customer information acquired by the information acquirer 130.

The recommender 200 of which a relationship is generated by the recommendation relationship generator 140 becomes a person corresponding to the recommender information included in the coupon. The recommendee becomes an entity that receives the coupon and registers the serial number of the coupon. The recommender 200 of which the relationship is generated by the recommendation relationship generator 140 may be regarded as an upper member and the recommendee may be regarded as a lower member. The recommender 200 and the recommendee may constitute a multistage form.

That is, the information acquirer 130 may acquire recommender information without receiving separate recommender information from the recommendee to acquire the recommender information in a circumstance such as a member join or a product purchase. The recommendation relationship generator 140 may generate the recommendation relationship using the recommender information acquired by the information acquirer 130.

Accordingly, when the potential customer 300 registers or uses the coupon, the recommendation relationship generating system 100 according to the present invention may generate the recommender-and-recommendee relationship without receiving separate recommender information.

When the recommender-and-recommendee relationship is generated by the recommendation relationship generator 140, the compensator 150 performs compensation for a financial activity of the recommendee.

That is, when a financial payment is made during a process in which the recommendee purchases a product using the corresponding coupon or purchases a product or uses a service in an offline shopping mall or an Internet shopping mall described in the coupon or described in contents sent together with the coupon, the compensator 150 may compensate the recommender 200 for reward corresponding to a predetermined rate of the made payment. The offline shopping mall or the Internet shopping mall described together with the coupon indicates an address of the online shopping mall or the offline shopping mall described in an SMS or as separate contents by the coupon sender when sending the coupon using the SMS.

Alternatively, the recommendation relationship between the recommender 200 and the potential customer 300 generated by the recommendation relationship generator 140 may be generated based on terms or a user agreement, and the like even at a place at which the potential customer 300 do not perform a member join or use the coupon. Accordingly, the compensator 150 may provide compensation to the recommender 200 according to a financial activity of the potential customer 300 that is a recommendee at a place at which the recommendation relationship is generated.

The compensation may be provided in various financial types such as cash, mileage, a gift certificate, a coupon, and the like. The predetermined rate of the made payment may vary based on the number of persons corresponding to recommendees of the corresponding recommender 200.

For example, the compensator 150 may compensate, as mileage, 7% of a purchase amount of recommendees when the number of persons corresponding to recommendees of the recommender 200 or the number of persons of a lower level is 50 or more, 5% of a purchase amount of recommendees when the number of persons is 10 or more, and 3% of a purchase amount of recommendees when the number of persons is 9 or less. The number of persons and the predetermined rate of the purchase amount may be changed.

Describing the number of persons of the lower level, when the recommender-and-recommendee relationship is generated by the recommendation relationship generator 140 and the generated recommender 200 is A and the recommendee is B, B may become the recommender 200 again and thereby form a recommendation relationship with another recommendee C. In this case, C becomes a person of a lower level of A. That is, the recommendation relationship generated by the recommendation relationship generator 140 may become a multistage form. From perspective of A, persons of the lower level may be B, C, a recommendee of C, and the like.

Compared to a general purchaser that does not have the recommender 200, a recommendee that has the recommender 200 for aggressive generation of the recommendation relationship or aggressive marketing may bring greater revenues when purchasing a product. Such revenues may be a further higher rate of mileage saving and a product discount.

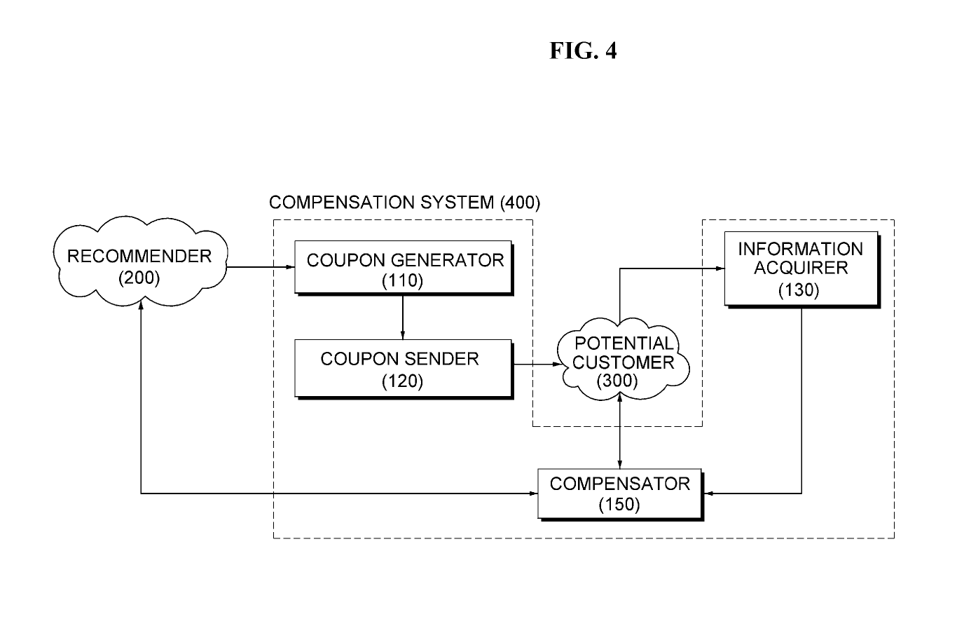

FIG. 4 is a block diagram illustrating a compensation system according to an exemplary embodiment of the present invention.

Referring to FIG. 4, a configuration of the compensation system 400 is identical to the recommendation relationship generating system 100, except that the recommendation relationship generator 140 is absent. When a recommendation relationship is not generated since the information acquirer 130 does not acquire information capable of identifying the potential customer 300, however, the potential customer 300 uses a coupon, the compensation system 400 may provide compensation to the recommender 200.

That is, it does not mean that only when the recommendation relationship is generated, the compensator 150 is capable of providing compensation to the recommender 200 that provides the coupon. When the information acquirer 130 acquires recommender information due to use of the coupon including information of the recommender 200, the compensator 150 may provide compensation to the recommender 200 with respect to a predetermined rate of a product purchase or a service use amount having occurred due to use of the coupon, irrespective of whether the recommendation relationship is generated.

The compensation system 400 may be identical to the configuration of the recommendation relationship generating system 100. In this case, whether to generate the recommendation relationship and to provide compensation or whether to provide only compensation without generating the recommendation relationship may vary based on whether identification information of the potential customer 300 is included in information acquired by the information acquirer 140.

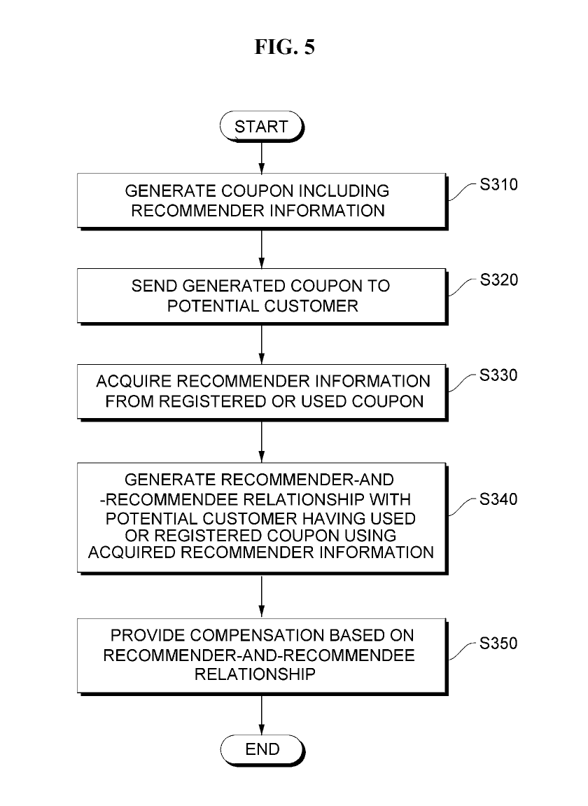

FIG. 5 is a flowchart illustrating a recommendation relationship generating method according to an exemplary embodiment of the present invention.

Referring to FIG. 5, in the recommendation relationship generating method, the coupon generator 110 generates a coupon including recommender information of the recommender 200 (operation S310).

The coupon sender 120 sends the coupon generated by the coupon generator 110 to the potential customer 300 (operation S320).

The information acquirer 130 acquires the recommender information from the coupon registered or used by the potential customer 300 (operation S330). Desirably, the coupon generator 110 includes the recommender information in a serial number of the coupon, and the information acquirer 130 acquires the recommender information from the serial number of the registered or used coupon.

Without receiving separate recommender information, the recommendation relationship generator 140 may generate a recommender-and-recommendee relationship with the potential customer 300 having used or registered the coupon using the recommender information acquired by the information acquirer 130 (operation S340).

When the recommendation relationship generator 140 generates a relationship by determining a corresponding party of the recommender information included in the coupon as the recommender 200 and by determining the potential customer 300 having registered or used the coupon as the recommendee, the compensator 150 may provide compensation of a predetermined rate with respect to a financial activity of the recommendee (operation S350).

The recommendation relationship generating method according to the present invention may generate a recommender-and-recommendee relationship without performing a separate recommender registering operation.

Accordingly, the recommendation relationship generating method according to the present invention, a recommendee may register a recommender without having inconvenience and thus, an entity to be recommended may easily secure the recommendee.

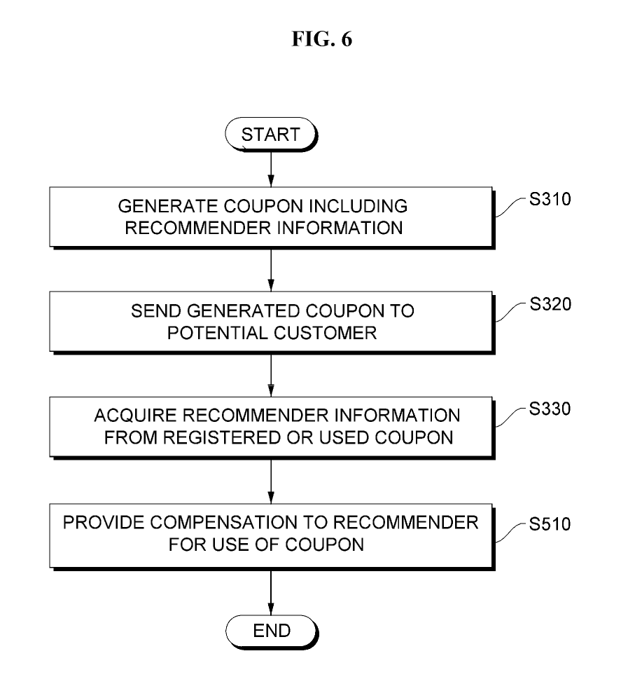

FIG. 6 is a flowchart illustrating a compensation method according to an exemplary embodiment of the present invention.

Referring to FIG. 6, it can be seen that operations S310 through S330 are identical to the flowchart of FIG. 5. Here, operation S330 may correspond to only a case in which the information acquirer 130 acquires information only with respect to a used coupon not a registered coupon. It is because the compensation method according to the present invention corresponds to a case (operation S510) in which since identification information of the potential customer 300 is not acquired during an information acquiring process of the recommendation relationship generating method, a recommendation relationship may not be generated, however, compensation is provided to the recommender 200 for use of the coupon. Here, when identification information of the potential customer 300 is not acquired according to a coupon registration and compensation is to be provided for that registration of the coupon has improved a potential product purchase probability, the compensation method according to the present invention may also provide compensation.

The recommendation relationship generating method according to the present invention may be combined with another recommendation relationship generating method and thereby utilized.

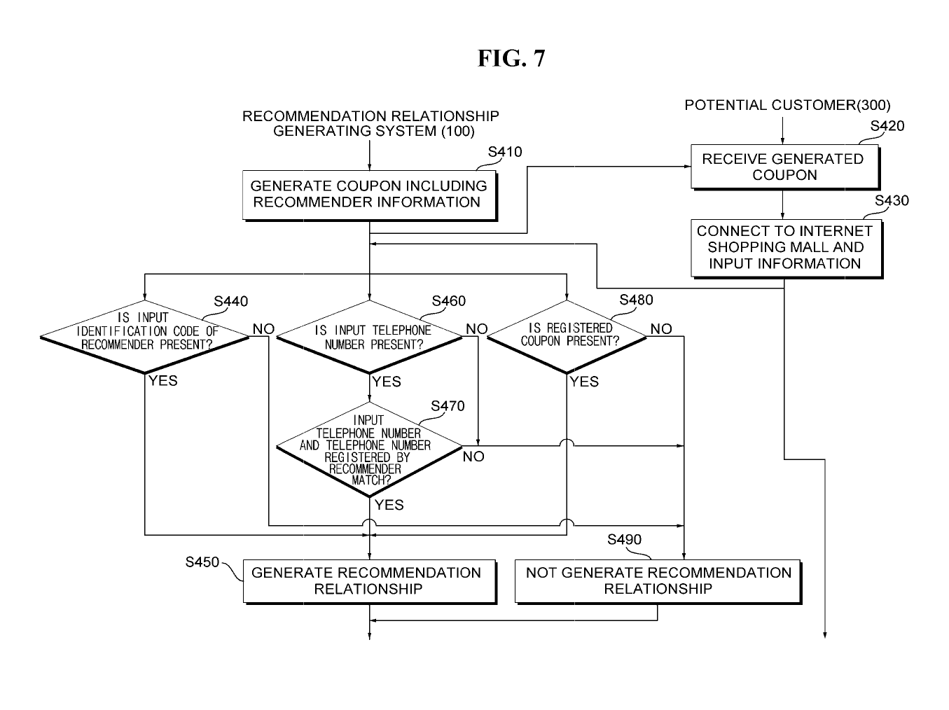

FIG. 7 is a flowchart illustrating a recommendation relationship generating method according to another exemplary embodiment of the present invention.

Describing the recommendation relationship generating method according to another exemplary embodiment with reference to FIG. 7, when the recommendation relationship generating system 100 generates a coupon including recommender information of the recommender 200 (operation S410), and the potential customer 300 having received the generated coupon connects to an Internet shopping mall and joins a member (operations S420 and S430), the potential customer 300 may input at least one of an identification code of the recommender 200, a telephone number, and a serial number of the coupon through the connected Internet shopping mall. The telephone number may be a telephone number of the potential customer 300 inputting the telephone number.

When inputting the identification code of the recommender 200, the telephone number, or the serial number of the coupon, the potential customer 300 may sequentially input information as illustrated in FIG. 4. However, the order may be changed. The potential customer 300 may select and thereby input only any one or two of the identification code of the recommender 200, the telephone number, and the serial number of the coupon.

The recommendation relationship generating system 100 acquires information input from the potential customer 300 with respect to the identification code of the recommender 200, the telephone number, or the serial number of the coupon, and generates the recommendation relationship using the acquired information (operation S450).

Acquiring the identification code of the recommender 200, the telephone number, or the serial number of the coupon input from the potential customer 300 may be performed by the information acquirer 130 of the recommendation relationship generating system 100.

In detail, taking an example with reference to FIG. 7, when the identification code of the recommender 200 input from the potential customer 300 is present, the recommendation relationship generating system 100 may generate the recommendation relationship between the recommender 200 corresponding to the identification code of the recommender 200 and the potential customer 300 having input the identification code of the recommender 200 (operations S440 and S450).

When the telephone number of the potential customer 300 is acquired, the recommendation relationship generating system 100 may generate the recommendation relationship between the recommender 200 having registered in advance the acquired telephone number of the potential customer 300 and the potential customer 300 (operations S460, S470, and S450). The recommender 200 may register, to a database in advance, the telephone number of the potential customer 300 predicted to form the recommendation relationship with the recommender 200.

When the serial number of the coupon is acquired, the recommendation relationship generating system 100 may acquire recommender information from the acquired serial number of the coupon and may generate the recommendation relationship between the recommender 200 corresponding to the acquired recommender information and the potential customer 300 having input the serial number of the coupon (operations S480 and S450).

When the potential customer 300 does not input any one of the identification code of the recommender 200, the telephone number, and the serial number of the coupon, the recommendation relationship generating system 100 may not generate the recommendation relationship.

As illustrated in FIG. 6, in the recommendation relationship generating method according to another exemplary embodiment, a process of acquiring at least one of the identification code of the recommender 200, the telephone number, and the serial number of the coupon input from the potential customer 300, and generating the recommendation relationship using the same may be performed in parallel. Also, in the recommendation relationship generating method according to another exemplary embodiment, information to be used to generate the recommendation relationship may become sequential based on when the potential customer 300 sequentially inputs the identification code of the recommender 200, the telephone number, and the serial number of the coupon, or when a system requires a sequential information input.

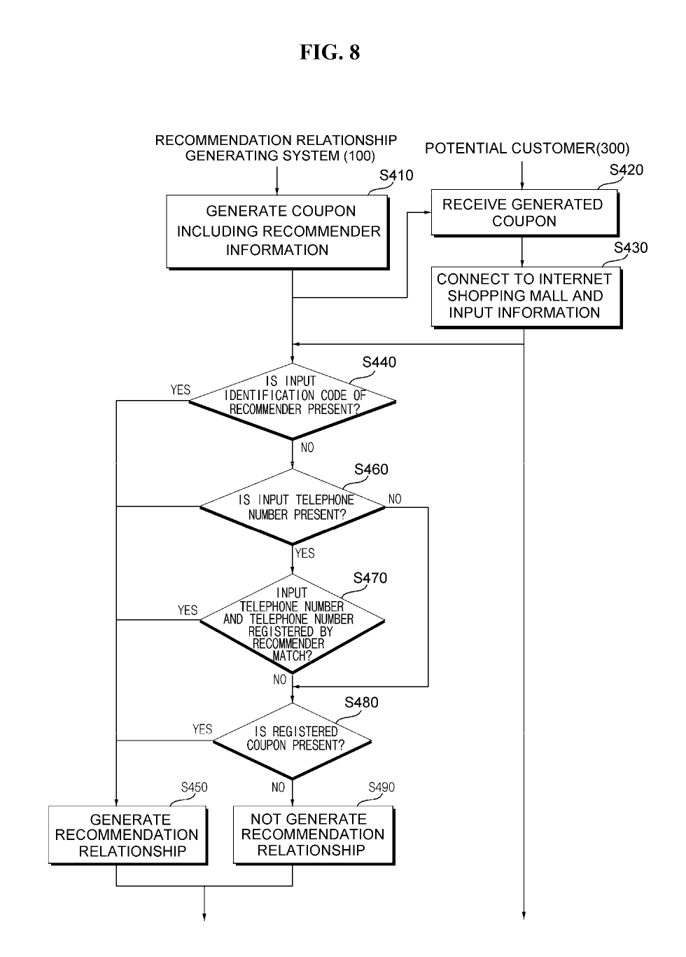

FIG. 8 is a flowchart illustrating a recommendation relationship generating method according to still another exemplary embodiment of the present invention.

Referring to FIG. 8, in the recommendation relationship generating method according to the present invention, an information input or generating of the recommendation relationship using the information input may have a sequential relationship rater than a parallel relationship, as illustrated in FIG. 7.

Initially, when the recommendation relationship generating system 100 according to the present invention acquires the identification code of the recommender 200, the recommendation relationship generating system 100 generates a recommendation relationship between the recommender 200 corresponding to the acquired identification code of the recommender 200 and the potential customer 300 having input the identification code of the recommender 200. When the recommendation relationship generating system 100 does not acquire the identification code of the recommender 200 and acquires the telephone number of the potential customer 300, the recommendation relationship generating system 100 may generate the recommendation relationship between the recommender 200 having registered in advance the acquired telephone number of the potential customer 300 and the potential customer 300.

When the recommendation relationship generating system 100 does not acquire information about the identification code of the recommender 200 and the telephone number of the potential customer 300 and acquires the serial number of the coupon, the recommendation relationship generating system 100 may acquire recommender information from the acquired serial number of the coupon and may generate the recommendation relationship between the recommender 200 corresponding to the acquired recommender information and the potential customer 300 having input the serial number of the coupon.

Block diagrams of the recommendation relationship generating system 100 according to an exemplary embodiment of the present invention and the compensation system 400 according to an exemplary embodiment of the present invention need to be understood to express the exemplary conceptual perspective of embodying the principle of the present invention. Similarly thereto, all the flowcharts need to be understood to express various processes performed by a computer or a processor regardless of whether the flowcharts may be substantially expressed in a computer-readable medium or whether the processor is clearly illustrated.

Functions of various devices illustrated in the drawings including a processor or a functional block indicated as a similar concept thereto may be provided with use of hardware having a capability of executing software in association with appropriate software as well as exclusive hardware. When the function is provided by the processor, the function may be provided by a single exclusive processor, a single shared processor, or a plurality of individual processors. A portion thereof may be shared.

Also, explicit use of a processor, a control, or terminology proposed as a concept similar thereto should not be interpreted by exclusively citing hardware having a capability of executing software, and should be understood to implicitly include read only memory (ROM), random memory access (RAM), and non-volatile memory to store digital signal processor (DSP) hardware and software beyond limitation. Other hardware already known may also be included.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A method of generating a recommendation relationship, the method comprising:
a coupon generating operation of generating a coupon including recommender information;
an information acquiring operation of acquiring identification information of a potential customer having registered or used the coupon and acquiring recommender information included in the registered or used coupon; and
a recommendation relationship generating operation of generating a recommendation relationship between the recommender and the potential customer using information acquired in the information acquiring operation.

2. The method of claim 1, wherein the coupon generating operation generates the coupon so that the recommender information is included in a serial number of the coupon.

3. The method of claim 2, wherein to generate the coupon so that the recommender information is included in the serial number of the coupon generates the coupon so that the recommender information is included using any one of a character corresponding to a predetermined portion of the serial number and a combination of characters corresponding to predetermined locations of the serial number.

4. The method of claim 2, wherein the serial number of the coupon includes at least one of an ID of the recommender, an employee identification number, and a telephone number of the recommender.

5. The method of claim 1, further comprising:
a compensation operation of providing compensation to the recommender based on a predetermined ratio of a financial activity scale of the potential customer with whom the recommendation relationship is generated spending at a place at which the recommendation relationship is applied.

6. The method of claim 5, wherein the compensation operation varies the predetermined ratio based on the number of recommendees of the recommender.

7. The method of claim 1, further comprising:
a coupon sending operation of sending the coupon generated in the coupon generating operation to the potential customer.

8. The method of claim 7, wherein the coupon sending operation sends the generated coupon using at least one of a short message service (SMS), a multimedia message service (MMS), a mobile messenger, and an e-mail.

9. A system for generating a recommendation relationship, the system comprising:
a coupon generator configured to generate a coupon including recommender information;
an information acquirer configured to acquire identification information of a potential customer having registered or used the coupon, and to acquire recommender information included in the registered or used coupon; and
a recommendation relationship generator configured to generate a recommendation relationship between the recommender and the potential customer using information acquired by the information acquirer.

10. The system of claim 9, wherein the coupon generator generates the coupon so that the recommender information is included in a serial number of the coupon.

11. The system of claim 10, wherein the serial number of the coupon includes at least one of an ID of the recommender, an employee identification number, and a telephone number of the recommender.

12. The system of claim 10, wherein to generate the coupon so that the recommender information is included in the serial number of the coupon generates the coupon so that the recommender information is included using any one of a character corresponding to a predetermined portion of the serial number and a combination of characters corresponding to predetermined locations of the serial number.

13. The system of claim 9, further comprising:
a compensator configured to provide compensation to the recommender based on a predetermined ratio of a financial activity scale of the potential customer with whom the recommendation relationship is generated spending at a place at which the recommendation relationship is applied.

14. The system of claim 13, wherein the compensator varies the predetermined ratio based on the number of recommendees of the recommender.

15. The system of claim 9, further comprising:
a coupon sender configured to send the coupon generated by the coupon generator to the potential customer.

16. The system of claim 15, wherein the coupon sender sends the generated coupon using at least one of an SMS, an MMS, a mobile messenger, and an e-mail.

17. A method of generating a recommendation relationship between a recommender and a potential customer, the method comprising:
an information acquiring operation of acquiring information of at least one of an identification code of the recommender, a telephone number of the potential customer, and a serial number of a coupon including information of the recommender; and
a recommendation relationship generating operation of generating a recommendation relationship using the acquired information.

18. The method of claim 17, wherein the recommendation relationship generating operation generates the recommendation relationship between the recommender corresponding to the acquired identification code of the recommender and the potential customer having input the identification code of the recommender when the identification code of the recommender is acquired in the information acquiring operation,
generates the recommendation relationship between the recommender having registered in advance the acquired telephone number of the potential customer and the potential customer when the telephone number of the potential customer is acquired in the information acquiring operation, and
acquires recommender information from the acquired serial number of the coupon, and generates the recommendation relationship between the recommender corresponding to the acquired recommender information and the potential customer having input the serial number of the coupon when the serial number of the coupon is acquired in the information acquiring operation.

19. The method of claim 18, wherein the acquiring of the recommender information from the serial number of the coupon acquires the recommender information using any one of a character corresponding to a predetermined portion of the serial number and a combination of characters corresponding to predetermined locations of the serial number.

20. The method of claim 18, wherein the serial number of the coupon includes at least one of an ID of the recommender, an employee identification number, and a telephone number of the recommender.

21. The method of claim 17, further comprising:
a compensation operation of providing compensation to the recommender based on a predetermined ratio of a financial activity scale of the potential customer with whom the recommendation relationship is generated spending at a place at which the recommendation relationship is applied.

22. The method of claim 21, wherein the compensation operation varies the predetermined ratio based on the number of recommendees of the recommender.

23. The method of claim 17, further comprising:
a coupon sending operation of sending the coupon including the recommender information to the potential customer.

24. The method of claim 23, wherein the coupon sending operation sends the generated coupon using at least one of an SMS, an MMS, a mobile messenger, and an e-mail.

25. A method of generating a recommendation relationship between a recommender and a potential customer, the method comprising:
generating the recommendation relationship between the recommender corresponding to an acquired identification code of the recommender and the potential customer having input the identification code of the recommender when the identification code of the recommender is acquired;
generating the recommendation relationship between the recommender having registered in advance an acquired telephone number of the potential customer and the potential customer when the identification code of the recommender is not acquired and the telephone number of the potential customer is acquired; and
acquiring recommender information from an acquired serial number of a coupon, and generating the recommendation relationship between the recommender corresponding to the acquired recommender information and the potential customer having input the serial number of the coupon when information about the identification code of the recommender and the telephone number of the potential customer are not acquired and the serial number of the coupon is acquired.

26. The method of claim 25, wherein the acquiring of the recommender information from the serial number of the coupon acquires the recommender information using any one of a character corresponding to a predetermined portion of the serial number and a combination of characters corresponding to predetermined locations of the serial number.

27. The method of claim 25, wherein the serial number of the coupon includes at least one of an ID of the recommender, an employee identification number, and a telephone number of the recommender.

28. The method of claim 25, further comprising:
a compensation operation of providing compensation to the recommender based on a predetermined ratio of a financial activity scale of the potential customer with whom the recommendation relationship is generated spending at a place at which the recommendation relationship is applied.

29. The method of claim 28, wherein the compensation operation varies the predetermined ratio based on the number of recommendees of the recommender.
